(19) United States
(12) Patent Application Publication
(10) Pub. No.: US 2017/0083978 A1
(43) Pub. Date: Mar. 23, 2017

(54) METHODS AND SYSTEMS FOR DETERMINING A BOND PROGRAM TO FINANCE A SCHOOL DISTRICT

(71) Applicant: Dale Scott & Company, San Francisco, CA (US)

(72) Inventor: Dale A. Scott, San Francisco, CA (US)

(21) Appl. No.: 14/857,755

(22) Filed: Sep. 17, 2015

(51) Int. Cl. G06Q 40/06; G06Q 40/00; G06Q 50/20

(52) U.S. Cl. CPC G06Q 40/06; G06Q 50/20; G06Q 40/10

(57) ABSTRACT

Introduced are methods and systems for determining a bond program to finance a school district. First, the system selects a school district that is qualified to participate in a short-term or a hybrid bond program. Second, based on various inputs, the system calculates a bond program that meets the financial and timeline requirements associated with a school district.

### TECHNICAL FIELD

Various embodiments relate generally to a computer method and system for determining a bond program to finance a school district.

### BACKGROUND

In November 2000, California voters passed Proposition 39 (“Prop 39”), lowering the required voter approval rate for school district and community college district (“K-14”) general obligation bonds to 55% from the previous 66.7% threshold. Prior to the approval of this constitutional amendment, the state legislature enacted a number of regulations governing the issuance of bonds under Prop 39 should it pass.

Among these regulations was one imposing a tax rate limitation ($60 per $100,000 of assessed valuation for unified school districts, $30 for high school and elementary districts and $25 for community college districts) on bonds sold under Prop 39. The tax rate limitation imposes the maximum legal tax rate that can be levied on private property associated with a school district. The tax levied under proposition 39 is used to pay off the debt raised when the school district issues general obligation bonds to raise money to pay for improvements in the school district.

Conventionally, the general obligation bonds are issued in multiple series, over a long period of time. Specifically, this long-term bond program is structured so that repayment stretches over multiple years, typically 25 to 35 years. In doing so, the school districts issuing bonds are able to leverage against the receipt of future tax payments in order to fund current projects. So, for example, a school district which will be receiving $1 million of tax revenue per year for the next 25 years can borrow approximately $14 million at a 5% interest rate. The remaining $11 million would be required to repay the cost of the borrowing.

Under this conventional bond model, the terms of a borrowing are locked in as of the date of issuance and future elected officials or public administrators have no power to alter these terms.

### SUMMARY

Introduced are methods and systems for determining a bond program to finance a school district.

In one embodiment, the processor 50 calculates a short-term bond program. First, the processor 50 selects a school district based on various inputs, such as a range of financing and timeline requirements associated with the school district, a prior debt amount associated with a school district, and a projected tax receipts associated with the school district for approximately next 3 to 6 years. Second, the processor 50 calculates a short-term bond program based on various inputs such as an assessed valuation associated with the selected school district, a historic growth rate associated with assessed valuations associated with the selected school district, a range of financing and timeline requirements associated with the selected school district, a projected bond interest rate on future borrowings, a range associated with a bond series term, and a legal maximum tax rate under proposition 39. The processor 50 calculates the short-term bond program comprising: a tax rate on private property associated with the school district, wherein the tax rate does not exceed the legal maximum tax rate under proposition 39; a number of bond series; a dollar amount associated with each of the bond series; and a term associated with each of the bond series.

In another embodiment, the processor 50 calculates a hybrid bond program. First, the processor 50 selects a school district based on various inputs such as a projected tax receipt associated with the school district for approximately next 3 to 6 years. Second, the processor 50 calculates a maximum amount of finances that can be raised with a short-term bond program based on various inputs such as an assessed valuation associated with the selected school district, a historic growth rate associated with assessed valuations associated with the selected school district, a range of financing and timeline needs associated with the selected school district, a range of projected bond interest rates on future borrowings, and a legal maximum tax rate under proposition 39. Third, based on the difference between the financing and timeline needs associated with a school district in the maximum amount of finances that can be raised with a short-term bond program, the processor 50 calculates a financing plan comprising the short-term bond program and the long-term bond program.

### BRIEF DESCRIPTION OF THE DRAWINGS

These and other objects, features and characteristics of the present embodiments will become more apparent to those skilled in the art from a study of the following detailed description in conjunction with the appended claims and drawings, all of which form a part of this specification. While the accompanying drawings include illustrations of various embodiments, the drawings are not intended to limit the claimed subject matter.

FIG. 1 is a diagram of a system for determining a plan for financing a school district with short-term and hybrid bonds, according to various embodiments in the disclosure.

FIG. 2 is a flowchart of steps taken by the processor in calculating a bond program, according to one embodiment.

FIG. 3 is a flowchart of steps taken by the processor in calculating a short-term bond program, according to one embodiment.

FIG. 4 is a flowchart of steps taken by the processor in calculating a hybrid bond program, according to one embodiment.

FIG. 5 is a diagrammatic representation of a machine in the example form of a computer system 500 within which a set of instructions, for causing the machine to perform any one or more of the methodologies or modules discussed herein, may be executed.

### DETAILED DESCRIPTION

Examples of a method and system for determining a bond program to finance a school district. In the following description, for the purposes of explanation, numerous specific details are set forth in order to provide a thorough understanding of the embodiments of the invention. One skilled in the art will recognize that the embodiments of the invention may be practiced without these specific details or with an equivalent arrangement. In other instances, well-known structures and devices are shown in block diagram form in order to avoid unnecessarily obscuring the embodiments of the invention.

### TERMINOLOGY

Brief definitions of terms, abbreviations, and phrases used throughout this application are given below.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not others.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements. The coupling or connection between the elements can be physical, logical, or a combination thereof. For example, two devices may be coupled directly, or via one or more intermediary channels or devices. As another example, devices may be coupled in such a way that information can be passed there between, while not sharing any physical connection with one another. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

If the specification states a component or feature “may,” “can,” “could,” or “might” be included or have a characteristic, that particular component or feature is not required to be included or have the characteristic.

The term “module” refers broadly to software, hardware, or firmware components (or any combination thereof). Modules are typically functional components that can generate useful data or another output using specified input(s). A module may or may not be self-contained. An application program (also called an “application”) may include one or more modules, or a module may include one or more application programs.

The terminology used in the Detailed Description is intended to be interpreted in its broadest reasonable manner, even though it is being used in conjunction with certain examples. The terms used in this specification generally have their ordinary meanings in the art, within the context of the disclosure, and in the specific context where each term is used. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, but special significance is not to be placed upon whether or not a term is elaborated or discussed herein. A recital of one or more synonyms does not exclude the use of other synonyms. The use of examples anywhere in this specification, including examples of any terms discussed herein, is illustrative only and is not intended to further limit the scope and meaning of the disclosure or of any exemplified term. Likewise, the disclosure is not limited to various embodiments given in this specification.

### Overview

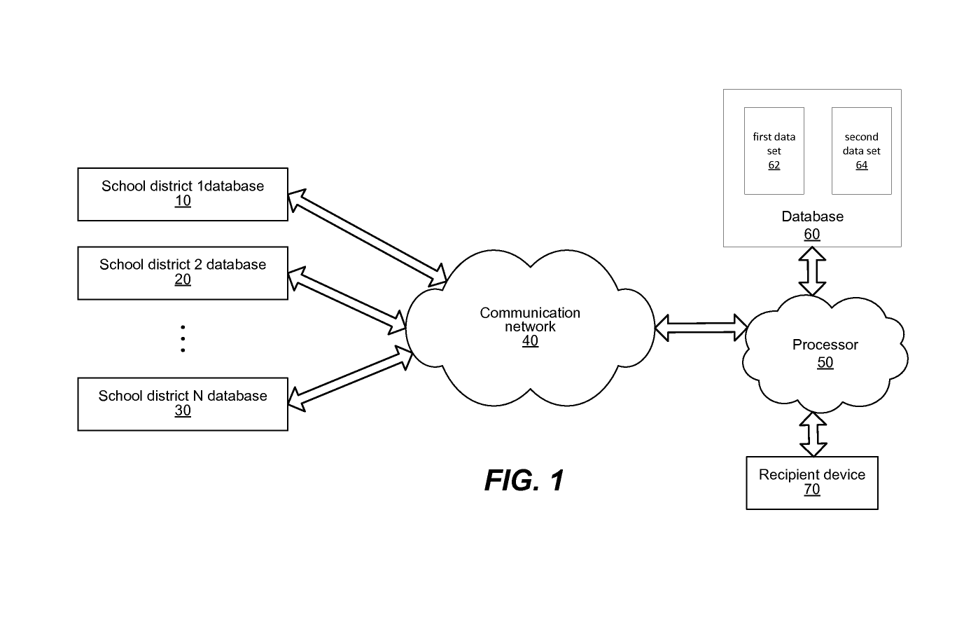

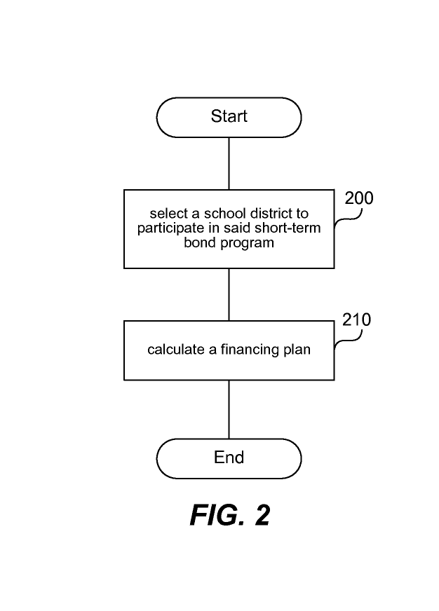

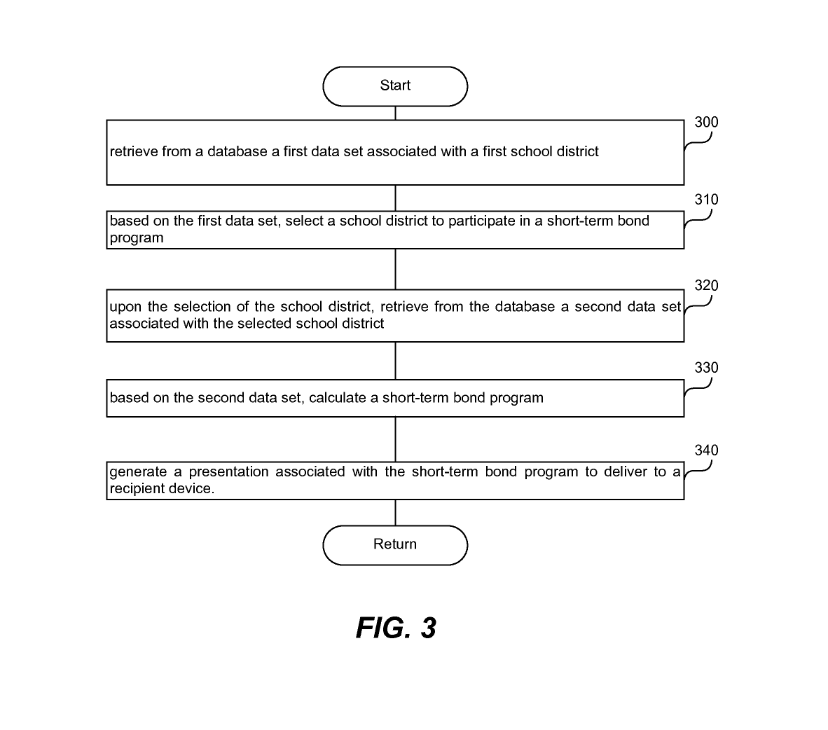

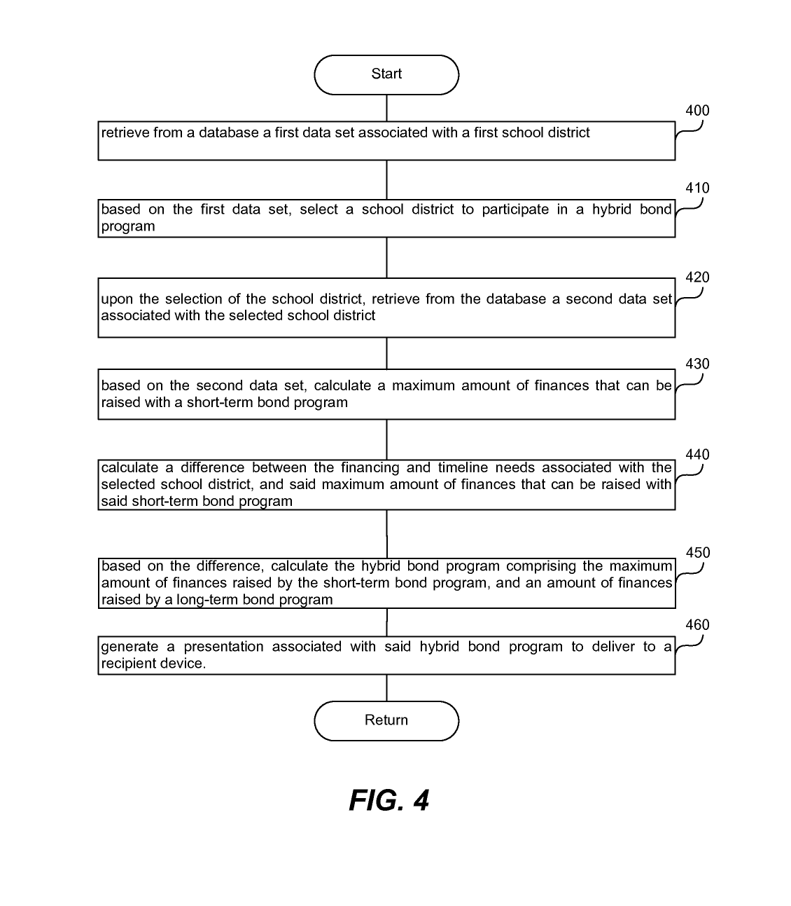

FIG. 1 is a diagram of a system for determining a plan for financing a school district with short-term and hybrid bonds, according to various embodiments in the disclosure. A plurality of databases 10, 20, 30 containing information corresponding to various school districts connect to a processor 50 via a communication network 40. The processor 50 stores the data it receives from databases 10, 20, 30 into the database 60, and divides the data into two data sets 62, 64. The two data sets 62, 64 can contain unique data, or can contain overlapping data. The processor 50 uses data set 62 in selecting an appropriate school district for short-term and hybrid bond program, in at least step 200 of FIG. 2, step 310 of FIG. 3, and step 410 of FIG. 4. The processor 50 can send the results of the selection to a recipient device 70. The processor 50 uses data set 64 in calculating a bond program for the school district, in at least step 210 of FIG. 2, step 330 of FIG. 3, and step 450 of FIG. 4. The processor 50 can generate a bond program presentation to deliver to a recipient device 70. The databases 10, 20, 30 and the processor 50, communicate with each other and other components of the communication network 40 using well known, new, or still developing protocols. In this context, a protocol includes a set of rules defining how the network nodes within the communication network 40 interact with each other based on information sent over the communication links.

By way of example, the communication network 40 includes one or more networks such as a data network, a wireless network, a telephony network, or any combination thereof. The data network may be any local area network (LAN), metropolitan area network (MAN), wide area network (WAN), a public data network (e.g., the Internet), short range wireless network, or any other suitable packet-switched network, such as a commercially owned, proprietary packet-switched network (e.g., a proprietary cable or fiber-optic network, and the like, or any combination thereof). In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The databases 10, 20, 30 can be stored on an Internet node, a server, a cloud, fixed terminal, station, unit, device, multimedia computer, desktop computer, laptop computer, notebook computer, netbook computer, tablet computer, or any combination thereof.

FIG. 2 is a flowchart of steps taken by the processor 50 in calculating a bond program, according to one embodiment. In step 200, the processor 50 selects a school district that is qualified to participate in a short-term or a hybrid bond program. In step 210, the processor 50 calculates a bond program that meets the financial and timeline requirements associated with a school district.

### Short-Term Bond Program

Unlike a conventional long-term bond program, the short-term bond program consist of a series of bonds issued sequentially with a much shorter amortization period, approximately 3 to 6 years, as opposed to 25 to 35 years in a traditional long-term bond program. As an example, the first series of the short-term bond program might only be amortized over five years. This results in not only a lower interest rate (e.g., 2.5% vs. 5%) but also reduced overall borrowing costs due to reduced leverage.

Once these bonds are paid off at the end of the five-year period, the borrower would receive the second installment of funding, also amortized over five years. Assuming this sequential issuance continued over the 25-year period, the issuer would have received approximately $23.23 million in project funding and paid only $1.77 million in interest, as opposed to $11 million in interest paid under the conventional long-term bond program.

FIG. 3 is a flowchart of steps taken by the processor 50 in calculating a short-term bond program, according to one embodiment. In step 300, the processor 50 retrieves from a database 60 a first data set 62 associated with a first school district, the first data set 62 comprising a range of financing and timeline requirements associated with the first school district, a prior debt amount associated with the first school district, and a projected tax receipt associated with the first school district for approximately next 3 to 6. According to one embodiment, the range of financing and timeline requirements includes a range of dates in the future, and a range of the desired amount of money to be received by the first school district at the specified future date. For example, the range of financing and timeline requirements can be represented by a data set such as: 2015-2016, $30-35 million; 2020-2022, $20-23 million; 2025-2027, $17-20 million. The prior debt amount associated with the school district includes information regarding how much debt the school district has incurred in the past. The school districts raise money by levying tax on private property within the school district. As the value of the private property rises, so does the income from the tax. The projected tax receipts are based on the projected tax rate and the projected property value.

In step 310, the processor 50, based on the first data set 62, selects a school district to participate in a short-term bond program. School districts are selected based on several criteria, such as having a significant amount of prior debt, having a low upfront cost, and having a sufficiently large assessed property valuation, such as total assessed property valuation is over $1 billion.

School districts which have issued large amounts of debt are presumed to have fulfilled their major facility construction and rehabilitation needs and are likely candidates for a short-term bond program. School district which have gone many years, such as more than 10 years, without a significant debt are assumed to have major upfront facility funding needs and are eliminated as likely candidates.

Because a short-term bond program does not leverage off tax receipts to be received many years in the future, the size of the borrowing is restricted to projected tax receipts received for a period of three to six years. As such, issuers with smaller tax bases would find the short-term bond program to be an inefficient form of borrowing since the fixed costs of issuing a bond series associated with a bond financing would be unreasonably high as a percentage of the borrowing. For this reason, the processor 50 selects school districts with a total assessed property valuation in excess of $1 billion as likely candidates for this program.

In step 320, the processor 50, upon the selection of the school district, retrieves from the database 60 a second data set 64, the second data set 64 comprising an assessed valuation associated with the selected school district, a historic growth rate associated with assessed valuations associated with the selected school district, a range of financing and timeline requirements associated with the selected school district, a projected bond interest rate on future borrowings, a range associated with a bond series term, and a legal maximum tax rate under proposition 39. The assessed valuation associated with the selected school district is the assessed property valuation, of the property associated with the school district. The historic growth rate associated with assessed valuation is the property valuation of the property associated with the school district, for the prior years. According to one embodiment, the range of financing and timeline requirements includes a range of dates in the future, and a range of desired amount of money to be received by the school district at the specified range of dates in the future. For example, the range of financing and timeline requirements can be represented by a data set such as: 2015-2016, $30-35 million; 2020-2022, $20-23 million; 2025-2027, $17-20 million. The projected bond interest rates on future borrowings are the interest rates associated with general obligation bonds in the future. The bond series term is the number of years, after issuing a bond series, when the school district needs to fully repay money raised with the bond series plus interest. The range associated with the bond series term for the short-term bond program is approximately 3 to 6 years. According to one embodiment, the second data set 64 further includes a range associated with the number of bond series. The range associated with the number of bond series specifies how many bond series can be issued. The range can vary from 1 bond series to infinitely many bond series. According some embodiments, the range can vary from approximately 1 to 10 bond series.

In step 330, the processor 50, based on the second data set, calculates a short-term bond program by determining: a tax rate on private property associated with the school district, wherein the tax rate does not exceed the legal maximum tax rate under proposition 39; a number of bond series; a dollar amount associated with each bond series; and a term associated with the bond series. If a range associated with the number of bond series is specified, the number of bond series must fall within the specified range. The dollar amount associated with each bond series plus the interest paid on the dollar amount cannot exceed the income received from the money raised by taxing the private property. The term associated with the bond series varies approximately between 3 to 6 years.

According to one embodiment, the processor 50 calculates the short-term bond program by running a plurality of calculation iterations, each calculation iteration comprising varying the tax rate for each bond issuance, wherein the tax rate does not exceed the legal maximum tax rate under proposition 39, until the short-term bond program is within the range of financing and timeline requirements associated with the selected school district.

According to another embodiment, the calculation iteration further comprises: varying the number of bond issuances, and varying the term associated with each of the bond series, until the short-term bond program is within the range of financing and timeline requirements associated with the selected school district.

According to one embodiment, in calculating the short-term bond program, the processor 50 calculates interest payment amounts, estimated short-term bond series costs, debt ratio, total proceeds, and estimated savings realized by using the short-term bonds.

In step 340, the processor 50, generates a presentation associated with the short-term bond program to deliver to the recipient device 70. The presentation may be in the form of a PowerPoint presentation, Excel spreadsheet, a multimedia presentation including audio, video, and image presentation. The presentation can comprise a video of projected financing over time, and how the projected financing varies with varying parameters such as varying tax rates, varying number of bond series, varying dollar amount associated with each bond series, varying term associated with each bond series, varying bond interest rates on future borrowings, varying valuations associated with the selected school district, etc.

According to one embodiment, in step 340, the processor 50, after calculating the short-term bond program, generates a payment to the recipient device 70. The payment is generated according to the calculated short-term bond program. For example, the short-term bond program consists of 3 bond series: $40 million for the first bond series with three-year term; $35 million for the second bond series with a four-year term; and a $30 million for the third board series with a six-year term. First, the processor 50, generates a $40 million payment to the recipient device 70. After 3 years, the processor 50, generates a $35 million payment to the recipient device 70. After 7 years, the processor 50 generates a $30 million payments to the recipient device 70.

### Hybrid Bond Program

Hybrid bonds include both short-term bonds, and traditional long-term bonds. Hybrid bonds enable a school district with large upfront costs that cannot be financed through a short-term bond program, to make up the difference in the school district's financial need and the maximum finances available through a short-term bond program, with a traditional long-term bond program. The hybrid bond program still saves the school district a significant amount of money in interest paid.

FIG. 4 is a flowchart of steps taken by the processor 50 in calculating a hybrid bond program, according to one embodiment. In step 400, the processor 50 retrieves from a database 60 a first data set 62 associated with a school district, the first data set 62 comprising a projected tax receipts associated with the school district for approximately next 3 to 6 years. The school districts raise money by levying tax on private property within the school district. As the value of the private property rises, so does the income from the tax. The projected tax receipts are based on the projected tax rate and the projected property value.

In step 410, the processor 50, based on the first data set 62, selects a school district to participate in the hybrid bond program. School districts are selected based on several criteria, such as high upfront cost that cannot be financed through a short-term bond program, already having an established long-term bond program, and having a sufficiently large assessed valuation, such as total assessed property valuation is over $1 billion.

In step 420, the processor 50, upon the selection of the school district, retrieves from the database 60 a second data set 64, the second data set 64 comprising an assessed valuation associated with the selected school district, a historic growth rate associated with assessed valuations associated with the selected school district, a range of financing and timeline requirements associated with the selected school district, a range of projected bond interest rate on future borrowings, and a legal maximum tax rate under proposition 39. The assessed valuation associated with the selected school district is the assessed property valuation of the property associated with the school district. The historic growth rate associated with assessed valuation is the property valuation of the property associated with the school district, for the prior years. According to one embodiment, the range of financing and timeline requirements includes a range of dates in the future, and a range of desired amount of money to be received by the school district at the specified range of dates in the future. For example, the range of financing and timeline requirements can be represented by a data set such as: 2015-2016, $30-35 million; 2020-2022, $20-23 million; 2025-2027, $17-20 million. The projected bond interest rates on future borrowings are the interest rates associated with general obligation bonds in the future. The bond series term is the number of years, after issuing a bond series, when the school district needs to fully repay money raised with the bond series plus interest. The range associated with the bond series term for the short-term bond program is approximately 3 to 6 years. According to one embodiment, the second data set 64 further includes a range associated with the number of bond series. The range associated with the number of bond series specifies how many bond series can be issued. The range can vary from 1 bond series to infinitely many bond series. According some embodiments, the range can vary from approximately 1 to 10 bond series.

In step 430, the processor 50, based on the second data set, calculates a maximum amount of finances that can be raised with a short-term bond program. The maximum amount of finances is calculated by: setting a tax rate associated with the short-term bond program approximately equal to the legal maximum tax rate under proposition 39; setting a term associated with each bond series equal to a maximum term of a single bond series, such as 6 years; and setting projected growth rate associated with assessed valuations equal to maximum historic growth rate. The tax rate associated with the short-term bond program can be set to anywhere between 50% to 100% of the legal maximum tax rate under proposition 39. In addition, the processor 50 calculates a number of bond series, so that the length of the short-term bond program satisfies the specified timeline requirements associated with the selected school district. For example, the number of short-term bond series is equal to the length of the timeline requirements associated with the selected school district divided by the maximum length of a single bond series, for example 6 years.

In step 440, the processor 50 calculates a difference between the financing and timeline needs, and the maximum amount of finances that can be raised with the short-term bond program. In step 450, the processor 50, based on the difference, calculates the hybrid bond program comprising the maximum amount of finances raised by the short-term bond program, and an amount of finances raised by a long-term bond program. According to one embodiment, in calculating the hybrid bond program, the processor 50 calculates interest payment amounts, estimated short-term bond series costs, debt ratio, total proceeds, and estimated savings realized by using the short-term bonds.

According to one embodiment, the long term bond program has already been established, and the processor 50 only calculates a short-term bond program. In that case, the processor 50 takes as input the financing provided by the long-term bond program, in step 320 of FIG. 3, and calculates the short-term bond program, in step 330 of FIG. 3.

In step 460, the processor 50, generates a presentation associated with hybrid bond program to deliver to the recipient device 70. The hybrid bond program presentation may be in the form of a PowerPoint presentation, Excel spreadsheet, a multimedia presentation including audio, video, and image presentation. The presentation can comprise a video of projected financing over time, and how the projected financing varies with varying parameters such as varying tax rates, varying number of bond series, varying dollar amount associated with each bond series, varying term associated with each bond series, varying bond interest rates on future borrowings, varying valuations associated with the selected school district, varying amount of finances raised by the short-term bond program, etc.

### Computer

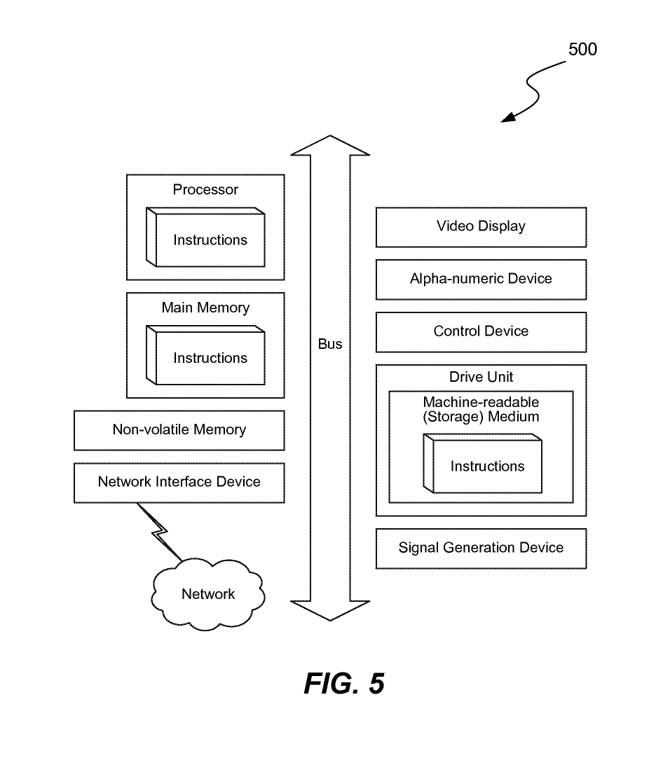

FIG. 5 is a diagrammatic representation of a machine in the example form of a computer system 500 within which a set of instructions, for causing the machine to perform any one or more of the methodologies or modules discussed herein, may be executed.

In the example of FIG. 5, the computer system 500 includes a processor, memory, non-volatile memory, and an interface device. Various common components (e.g., cache memory) are omitted for illustrative simplicity. The computer system 500 is intended to illustrate a hardware device on which any of the components described in the example of FIGS. 1-18 (and any other components described in this specification) can be implemented. The computer system 500 can be of any applicable known or convenient type. The components of the computer system 500 can be coupled together via a bus or through some other known or convenient device.

This disclosure contemplates the computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 500 may include one or more computer systems 500; be unitary or distributed; span multiple locations; span multiple machines; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer 500. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, storing and entire large program in memory may not even be possible. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system 500. The interface can include an analog modem, isdn modem, cable modem, token ring interface, satellite transmission interface (e.g. “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 9 reside in the interface.

In operation, the computer system 500 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all exam page on ples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

### Remarks

In many of the embodiments disclosed in this application, the technology is capable of allowing multiple different users to use the same piece of furniture equipped with the presently disclosed technology. For example, different people can sleep in the same bed. In addition, two different users can switch the side of the bed that they sleep on, and the technology disclosed here will correctly identify which user is sleeping on which side of the bed. The technology identifies the users based on any of the following signals alone or in combination: heart rate, breathing rate, body motion, or body temperature associated with each user.

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

While embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Although the above Detailed Description describes certain embodiments and the best mode contemplated, no matter how detailed the above appears in text, the embodiments can be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following claims.

1. A computer-implemented method comprising:
(a) retrieving, by a processor, from a database a first data set associated with a first school district, said first data set comprising a range of financing and timeline requirements associated with said first school district, a prior debt amount associated with said first school district, and a projected tax receipt associated with said first school district for next 3 to 6 years;
(b) based on said first data set, selecting, by said processor, a school district to participate in a short-term bond program, wherein said short-term bond program comprises a 3 to 6 year amortization period;
(c) upon said selection of said school district, retrieving, by said processor, from said database a second data set, said second data set comprising an assessed valuation associated with said selected school district, a historic growth rate associated with assessed valuations associated with said selected school district, a range of financing and timeline requirements associated with said selected school district, a projected bond interest rate on future borrowings, a range associated with a bond series term, and a legal maximum tax rate under proposition 39;
(d) based on said second data set, calculating, by said processor, a short-term bond program comprising:
determining, by said processor, a tax rate on private property associated with said school district, wherein said tax rate does not exceed said legal maximum tax rate under proposition 39;
determining, by said processor, a number of bond series;
determining, by said processor, a dollar amount associated with each said bond series;
determining, by said processor, a term associated with each said bond series; and
calculating interest payment amounts, estimated short-term bond series costs, debt ratio, total proceeds, and estimated savings realized by using said short-term bonds; and
(e) generating a presentation associated with said short-term bond program to deliver to a recipient device.

2. The method of claim 1, wherein said range associated with said bond series term comprises 3 to 6 years.

3. The method of claim 1, wherein said second data set further comprises a range associated with said number of bond series.

4. The method of claim 3, wherein said range associated with said number of bond series comprises 1 to 10 bond series.

5. The method of claim 1, wherein calculating said short-term bond program further comprises running a plurality of calculation iterations, said calculation iteration comprising:
varying, by said processor, said tax rate for each bond issuance, wherein said tax rate does not exceed said legal maximum tax rate under proposition 39, until said short-term bond program is within said range of financing and timeline requirements associated with said selected school district.

6. The method of claim 5, wherein said calculation iteration further comprises:
varying, by said processor, said number of bond series; and
varying, by said processor, said term associated with each said bond series;
until said short-term bond program is within said range of financing and timeline requirements associated with said selected school district.

7. (canceled)

8. The method of claim 1, wherein selecting a school district comprises:
selecting a school district when said school district has significant prior debt;
selecting said school district when said school district has low upfront cost; and
selecting said school district when said school district has sufficiently large assessed valuation.

9. The method of claim 1, wherein said second data set further comprises an amount of finances provided by a long-term bond program, said long-term bond program comprising 25 to 35 years amortization period.

10. A computer implemented method comprising:
(a) retrieving, by a processor, from a database a first data set associated with a first school district, said first data set comprising a projected tax receipt associated with said first school district for next 3 to 6 years;
(b) based on said first data set, selecting, by said processor, a school district to participate in a hybrid bond program;
(c) upon said selection of said school district, constantly retrieving, by said processor, from said database a second data set, including updates to said second data set, said second data set comprising an assessed valuation associated with said selected school district, a historic growth rate associated with assessed valuations associated with said selected school district, a range of financing and timeline needs associated with said selected school district, a range of projected bond interest rates on future borrowings, and a legal maximum tax rate under proposition 39;
(d) based on said second data set, repeatedly calculating, by said processor, a maximum amount of finances that can be raised with a short-term bond program, wherein said short-term bond program comprises a 3 to 6 year amortization period;
(e) calculating, by said processor, a difference between said financing and timeline needs, and said maximum amount of finances that can be raised with said short-term bond program;
(f) based on said difference, calculating, by said processor, said hybrid bond program comprising said maximum amount of finances raised by said short-term bond program, and an amount of finances raised by a long-term bond program, said long-term bond program comprising 25 to 35 years amortization period, said calculating comprising:
calculating interest payment amounts, estimated short-term bond series costs, debt ratio, total proceeds, and estimated savings realized by using said short-term bonds;
(g) generating a multimedia presentation associated with said hybrid bond program to deliver to a recipient device, said multimedia presentation comprising an automatically generated interactive webpage, said interactive webpage comprising instructions for:
receiving an input from the recipient device specifying at least one parameter, wherein the at least one parameter comprises said tax rate, said bond series, said dollar amount associated with each bond series, or said term associated with each bond series;
causing the recipient device to display an effect on said short-term bond program, said effect associated with a user-configurable value, said user-configurable value associated with said received parameter from the recipient device;
upon receiving a selection of said user-configurable value associated with said parameter from the recipient device, generating at an appropriate time a payment to said recipient device, said payment comprising a dollar amount associated with an upcoming bond series;
(f) updating in said database a range of said financing and timeline requirements associated with said selected school district to account for said payment; and
(g) repeatedly performing steps (c)-(f) until said financing and timeline requirements are satisfied.

11. The method of claim 10, wherein said calculating said maximum amount of finances comprises:
setting, by said processor, a tax rate associated with said short-term bond program approximately equal to said legal maximum tax rate under proposition 39;
setting, by said processor, a term associated with each bond series equal to a maximum term of a single bond series; and
setting, by said processor, projected growth rate associated with assessed valuations equal to maximum historic growth rate.

12. The method of claim 10, wherein said second data set further comprises a range associated with said number of bond series.

13. The method of claim 12, wherein said range associated with said number of bond series comprises approximately 1 to 10 bond series.

14. The method of claim 10, wherein selecting a school district comprises:
selecting said school district when said school district has an upfront cost that cannot be financed with a short-term bond program; and
selecting said school district when said school district has sufficiently large assessed valuation.

15. A computer-implemented method comprising:
(a) selecting a school district based on a financing and timeline requirement associated with said school district and a projected tax receipt associated with said first school district for a time period;
(b) calculating a short-term bond program, wherein said short-term bond program comprises a 3 to 6 year amortization period, associated with said selected school district, said calculating comprising:
calculating interest payment amounts, estimated short-term bond series costs, debt ratio, total proceeds, and estimated savings realized by using said short-term bonds.

16. The method of claim 15, wherein said calculating said short-term bond program comprises:
determining, by said processor, a tax rate on private property associated with said school district, wherein said tax rate does not exceed said legal maximum tax rate;
determining, by said processor, a number of bond series;
determining, by said processor, a dollar amount associated with each said bond series; and
determining, by said processor, a term associated with each said bond series.

17. A system comprising:
a processor;
a database comprising a first data set and a second data set;
a non-transitory storage medium storing computer-executable instructions that, when executed by said processor, cause said system to perform a computer-implemented operation, said instructions comprising:
(a) instructions for retrieving, by said processor, from said database said first data set associated with a first school district, said first data set comprising a range of financing and timeline requirements associated with said first school district, a prior debt amount associated with said first school district, and a projected tax receipt associated with said first school district for next 3 to 6 years associated with said first school district;
(b) based on said first data set, instructions for selecting, by said processor, a school district to participate in a short-term bond program, wherein said short-term bond program comprises a 3 to 6 year amortization period;
(c) upon said selection of said school district, instructions for retrieving, by said processor, from said database a second data set, said second data set comprising an assessed valuation associated with said selected school district, a historic growth rate associated with assessed valuations associated with said selected school district, a range of financing and timeline requirements associated with said selected school district, a projected bond interest rate on future borrowings, a range associated with a bond series term, and a legal maximum tax rate under proposition 39;
(d) based on said second data set, instructions for calculating, by said processor, a short-term bond program comprising:
instructions for determining, by said processor, a tax rate on private property associated with said school district, wherein said tax rate does not exceed said legal maximum tax rate under proposition 39;
instructions for determining, by said processor, a number of bond series;
instructions for determining, by said processor, a dollar amount associated with each said bond series;
instructions for determining, by said processor, a term associated with each said bond series;
instructions for running a plurality of calculation iterations, said calculation iteration comprising: instructions for varying, by said processor, said tax rate for each bond issuance, wherein said tax rate does not exceed said legal maximum tax rate under proposition 39, until said short-term bond program is within said range of financing and timeline requirements associated with said selected school district, wherein said calculation iteration further comprises:
instructions for varying, by said processor, said number of bond series; and
instructions for varying, by said processor, said term associated with each said bond series;
until said short-term bond program is within said range of financing and timeline requirements associated with said selected school district; and
(e) instructions for generating a presentation associated with said short-term bond program to deliver to a recipient device.

18. The system of claim 17, wherein said range associated with said bond series term comprises approximately 3 to 6 years.

19. The system of claim 17, wherein said second data set further comprises a range associated with said number of bond series, said range associated with said number of bond series comprises approximately 1 to 10 bond series.

20. (canceled)

21. (canceled)

22. The system of claim 17, wherein instructions for selecting a school district comprise:
instructions for selecting a school district when said school district has significant prior debt;
instructions for selecting said school district when said school district has low upfront cost; and
instructions for selecting said school district when said school district has sufficiently large assessed valuation.

23. The method of claim 1, wherein said generating the presentation comprises:
(f) generating a multimedia presentation associated with said short-term bond program to deliver to a recipient device, said multimedia presentation comprising an automatically generated interactive webpage, said interactive webpage comprising instructions for:
receiving an input from the recipient device specifying at least one parameter, wherein the at least one parameter comprises said tax rate, said bond series, said dollar amount associated with each bond series, or said term associated with each bond series;
causing the recipient device to display an effect on said short-term bond program, said effect associated with a user-configurable value, said user-configurable value associated with said received parameter from the recipient device;
upon receiving a selection of said user-configurable value associated with said parameter from the recipient device, generating at an appropriate time a payment to said recipient device, said payment comprising a dollar amount associated with an upcoming bond series;
(g) updating in said database a range of said financing and timeline requirements associated with said selected school district to account for said payment; and
(h) repeatedly performing steps (c)-(g) until said financing and timeline requirements are satisfied.

24. The method of claim 15, further comprising:
(c) generating a multimedia presentation associated with said short-term bond program to deliver to a recipient device, said multimedia presentation comprising an automatically generated interactive webpage, said interactive webpage comprising instructions for:
receiving an input from the recipient device specifying at least one parameter, wherein the at least one parameter comprises said tax rate, said bond series, said dollar amount associated with each bond series, or said term associated with each bond series;
causing the recipient device to display an effect on said short-term bond program, said effect associated with a user-configurable value, said user-configurable value associated with said received parameter from the recipient device;
upon receiving a selection of said user-configurable value associated with said parameter from the recipient device, generating at an appropriate time a payment to said recipient device, said payment comprising a dollar amount associated with an upcoming bond series;
(d) updating in a database a range of said financing and timeline requirements associated with said selected school district to account for said payment; and
(e) repeatedly performing steps (b)-(d) until said financing and timeline requirements are satisfied.

25. The method of claim 17, wherein said instructions for generating said presentation comprises:
(f) instructions for generating a multimedia presentation associated with said short-term bond program to deliver to a recipient device, said multimedia presentation comprising an automatically generated interactive webpage, said interactive webpage comprising:
instructions for receiving an input from the recipient device specifying at least one parameter, wherein the at least one parameter comprises said tax rate, said bond series, said dollar amount associated with each bond series, or said term associated with each bond series;
instructions for causing the recipient device to display an effect on said short-term bond program, said effect associated with a user-configurable value, said user-configurable value associated with said received parameter from the recipient device;
instructions for upon receiving a selection of said user-configurable value associated with said parameter from the recipient device, generating at an appropriate time a payment to said recipient device, said payment comprising a dollar amount associated with an upcoming bond series;
(g) instructions for updating in said database a range of said financing and timeline requirements associated with said selected school district to account for said payment; and
(h) instructions for repeatedly performing steps (c)-(g) until said financing and timeline requirements are satisfied.
